(19) United States
(12) Patent Application Publication
(10) Pub. No.: US 2024/0217220 A1
(43) Pub. Date: Jul. 4, 2024

(54) PACKAGING FILM, LAMINATED PACKAGE FILM AND PACKAGE

(71) Applicant: AMCOR FLEXIBLES NORTH AMERICA, INC., Neenah, WI (US)

(72) Inventors: Marcelo Brasil ELIAS, Appleton, WI (US); Otacilio T. BERBERT, Oshkosh, WI (US); Kevin J. CURIE, Appleton, WI (US); Ross K. GRUETZMACHER, Neenah, WI (US)

(21) Appl. No.: 18/287,860

(22) PCT Filed: Apr. 27, 2021
(86) PCT No.: PCT/US2021/029445

§ 371 Date: Oct. 20, 2023

(51) Int. Cl. B32B 27/08; B32B 27/20; B32B 27/30; B32B 27/32

(52) U.S. Cl. CPC B32B 27/08; B32B 27/20; B32B 27/306; B32B 27/32; B32B 27/325; B32B 27/327; B32B 2250/246; B32B 2255/10; B32B 2270/00; B32B 2307/306; B32B 2307/406; B32B 2307/514; B32B 2307/7244; B32B 2307/7246; B32B 2553/00

(57) ABSTRACT

A packaging film is disclosed. The packaging film includes a first layer and a second layer. The first layer has a first surface and an opposing second surface. The first layer includes a first layer cyclic olefin copolymer in an amount from 5% to 30% by weight of the first layer and a first layer polyolefin in an amount from 70% to 95% by weight of the first layer. The first layer and the second layer are coextruded to each other. The packaging film includes a gloss measurement of less than or equal to 50% when measured according to ASTM D-2457-08. Further, the first layer COC includes a glass transition temperature (Tg) of greater than or equal to 78 degree Celsius (° C.).

### TECHNICAL FIELD

The present disclosure relates, in general, to a packaging film. In particular, the present disclosure relates to a packaging film having a low gloss, and a package including the packaging film.

### BACKGROUND

Flexible films are generally used for packaging of products, particularly in grocery, consumer goods and industrial segment. Films having a low gloss are generally preferred for packaging of various products, such as pet food, personal healthcare products, cereals, etc. Films having the low gloss may also be referred to as films having a matte finish. Conventional packaging films with a low gloss include matte oriented polyethylene terephthalate (OPET) or matte oriented polypropylene (OPP) or films that include matte coatings. The conventional films including such matte OPET or OPP, and/or matte coatings introduce contaminates into a recycling stream, in particular, polyethylene recycling streams, such that conventional packaging films are not recyclable or detrimental to recycling. Further, the application of matte coatings on conventional films introduce additional manufacturing process steps. Conventional polyethylene packaging films have also been found to have a low thermal resistance.

In some cases, the conventional packaging films include micron sized inorganic materials to provide the low gloss. The micron sized inorganic materials cause micro-cavitation in one or more layers of oriented packaging film. However, such micro-cavitation may negatively affect clarity of the conventional packaging films.

In some cases, the conventional packaging films include matte masterbatches to provide the low gloss. However, such conventional packaging films may contaminate the recycling streams.

### SUMMARY

A packaging film having a low gloss has been developed. Such packaging film may be recyclable, have improved thermal resistance and be aesthetically appealing with a matte finish or appearance. The packaging film may be recyclable.

In an embodiment, a packaging film is disclosed. The packaging film includes a first layer having a first surface and an opposing second surface. The first layer includes a first layer cyclic olefin copolymer (COC) in an amount from 5% to 30% by weight of the first layer, and a first layer polyolefin in an amount from 70% to 95% by weight of the first layer. The packaging further includes a second layer disposed adjacent to the second surface of the first layer. The first layer and the second layer are coextruded to each other. The packaging film includes a gloss measurement of less than or equal to 50% when measured according to ASTM D-2457-08. Further, the first layer COC includes a glass transition temperature (Tg) of greater than or equal to 78 degree Celsius (° C.).

In some embodiments, the packaging film is a coextruded blown film.

In some embodiments, the packaging film is a coextruded cast film.

In some embodiments, the packaging film is oriented.

In some embodiments, the first layer polyolefin includes ultra-low-density polyethylene (ULDPE), low density polyethylene (LDPE), linear low-density polyethylene (LLDPE), medium density polyethylene (MDPE), linear medium density polyethylene (LMDPE), metallocene low density polyethylene (MLDPE), high density polyethylene (HDPE), ethylene vinyl acetate copolymer (EVA), or combinations thereof.

In some embodiments, the second layer comprises polyolefin polymers.

In some embodiments, the packaging film further includes a thermal resistance equal to or greater than 145 degree Celsius (° C.).

In some embodiments, the packaging film further includes an inorganic filler including calcium carbonate, calcium sulfate, mica, or other silicates.

In some embodiments, the packaging film further includes a third layer including a COC in an amount from 5% to 30% by weight of the third layer.

In some embodiments, the packaging film further includes a barrier layer.

In some embodiments, the packaging film further includes a sealant film including an exposed surface of the packaging film.

In some embodiments, the sealant film is laminated to the packaging film.

In an embodiment, a package including the packaging film of the previous embodiments is disclosed.

In yet another embodiment, a laminated packaging film is disclosed. The laminated packaging film includes a packaging film. The packaging film includes a first layer having a first surface and an opposing second surface. The first layer includes a first layer cyclic olefin copolymer (COC) in an amount from 5% to 30% by weight of the first layer and a first layer polyolefin in an amount from 70% to 95% by weight of the first layer. The packaging film further includes a second layer disposed adjacent to the second surface of the first layer. The laminated packaging film further includes a sealant film. The first layer and the second layer are coextruded to each other. The sealant film is laminated to the packaging film and includes an exposed surface of the packaging film. The packaging film includes a gloss measurement of less than or equal to 50% when measured according to ASTM D-2457-08. The first layer COC includes a glass transition temperature (Tg) of greater than or equal to 78 degree Celsius (° C.).

In some embodiments, the packaging film is oriented.

In some embodiments, the packaging film and the sealant film are laminated by heat, extrusion, or adhesive.

In some embodiments, the packaging film further includes printed indicia.

In some embodiments, the second layer includes polyolefin polymers.

In some embodiments, the packaging film further includes a thermal resistance equal to or greater than 145 degree Celsius (° C.).

In an embodiment, a package including the laminated packaging film of the previous embodiments is disclosed.

Since the packaging film includes a gloss measurement of less than or equal to 50% when measured according to ASTM D-2457-08, the packaging film of the present disclosure may have a low gloss. In other words, the packaging film may have a matte finish. The matte finish may provide visual appeal to the consumers. Further, the packaging film may not require application of matte coatings and thereby may not require any additional manufacturing processes.

Further, the first layer COC in the amount from 5% to 30% by weight of the first layer and having the glass transition temperature (Tg) of greater than or equal to 78 degree Celsius (° C.) may further improve the thermal resistance of the packaging film. The thermal resistance of the packaging film may be equal to or greater than 145° C. In addition, the first layer, including the first layer polyolefin in the amount from 70% to 95% by weight of the first layer, may reduce an amount of non-polyolefin-based polymers in the packaging film and may provide a better quality of recyclate. Further, the second layer including the polyolefin polymers may further reduce an amount of non-polyolefin-based polymers in the packaging film and may further improve the quality of recyclate.

In some cases, the packaging film may be fully recyclable.

In some cases, the inorganic filler in the packaging film may further reduce the gloss measurement of the packaging film. In some cases, the inorganic filler may further improve the thermal resistance of the packaging film.

Furthermore, the packaging film may exhibit improved stiffness and mechanical properties. Specifically, the packaging film may have an improved machinability that may allow for the packaging film to be downgauged. In other words, the packaging film may have a lower thickness than the conventional packaging films for similar applications.

There are several other aspects of the present subject matter which may be embodied separately or together. These aspects may be employed alone or in combination with other aspects of the subject matter described herein, and the description of these aspects together is not intended to preclude the use of these aspects separately or the claiming of such aspects separately or in different combinations.

### BRIEF DESCRIPTION OF THE DRAWINGS

The disclosure may be more completely understood in consideration of the following detailed description of various embodiments of the disclosure in connection with the accompanying drawings, in which:

FIG. 1 illustrates a cross-sectional view of a packaging film, in accordance with an embodiment of the present disclosure;

FIG. 2 illustrates a cross-sectional view of another packaging film, in accordance with an embodiment of the present disclosure;

FIG. 3 illustrates a cross-sectional view of another packaging film, in accordance with an embodiment of the present disclosure;

FIG. 4 illustrates a cross-sectional view of another packaging film, in accordance with an embodiment of the present disclosure;

FIG. 5 illustrates a cross-sectional view of a laminated packaging film, in accordance with an embodiment of the present disclosure;

FIG. 6A illustrates a cross-sectional view of another laminated packaging film, in accordance with an embodiment of the present disclosure;

FIG. 6B illustrates a cross-sectional view of another laminated packaging film, in accordance with an embodiment of the present disclosure;

FIG. 7 illustrates a perspective view of a package including the packaging film, for a product disposed therein, in accordance with an embodiment of the present disclosure;

FIG. 8 illustrates a plot depicting thermal resistance of different sample films, in accordance with an embodiment of the present disclosure; and

FIG. 9 illustrates a plot depicting stress versus strain curves of different sample films, in accordance with an embodiment of the present disclosure.

The figures are not necessarily to scale. Like numbers used in the figures refer to like components. It will be understood, however, that the use of a number to refer to a component in a given figure is not intended to limit the component in another figure labeled with the same number.

The drawings show some but not all embodiments. The elements depicted in the drawings are illustrative and not necessarily to scale, and the same (or similar) reference numbers denote the same (or similar) features throughout the drawings.

### DETAILED DESCRIPTION

The present disclosure relates to a packaging film with a low gloss. The packaging film may further be recyclable, provide improved quality of recyclate, have improved stiffness and improved mechanical properties and exhibit improved thermal resistance. The packaging film includes a first layer and a second layer. The first layer has a first surface and an opposing second surface. The first layer includes a first layer cyclic olefin copolymer in an amount from 5% to 30% by weight of the first layer and a first layer polyolefin in an amount from 70% to 95% by weight of the first layer. The first layer and the second layer are coextruded to each other. The packaging film includes a gloss measurement of less than or equal to 50% when measured according to ASTM D-2457-08. Further, the first layer COC includes a glass transition temperature (Tg) of greater than or equal to 78 degree Celsius (° C.).

The present disclosure further provides a laminated packaging film including the packaging film and a sealant film. The present disclosure further provides a package including the packaging film or the laminated packaging film, for a product disposed therein.

The packaging film of the present disclosure includes a gloss measurement of less than or equal to 50% when measured according to ASTM D-2457-08. Therefore, the packaging film may have a low gloss that is sometimes referred to as a packaging film having a matte finish that may provide visual appeal to the consumers. Further, the packaging film may reduce or eliminate the need for application of matte coatings such additional manufacturing processes are not necessary.

The first layer COC in the amount from 5% to 30% by weight of the first layer and having the glass transition temperature (Tg) of greater than or equal to 78° C. may further improve a thermal resistance of the packaging film that may be equal to or greater than 145° C. In some embodiments, the Tg may be greater than or equal to 78° C., 80° C., 125° C., 130° C., 134° C., 138° C., 158° C., or 178° C.

As used in the present disclosure, the term “film” is a material with a very high ratio of length or width to thickness. A film has two major surfaces defined by a length and width. Films typically have good flexibility and can be used for a wide variety of applications, including flexible packaging. Films may also be of thickness and/or material composition such that they are semi-rigid or rigid. Films described in the present disclosure are composed of various polymeric materials but may also contain other materials, such as metals or papers. Films may be described as monolayer or multilayer.

As used in the present disclosure, the term “layer” refers to a thickness of material within a film that has a relatively consistent formula. Layers may be of any type of material including polymeric, cellulosic, and metallic, or a blend thereof. A given polymeric layer may consist of a single polymer-type or a blend of polymers and may be accompanied by additives. A given layer may be combined or connected to other layers to form films. A layer may be either partially or fully continuous as compared to adjacent layers or the film. A given layer may be partially or fully coextensive with adjacent layers. A layer may contain sub-layers.

As used in the present disclosure, the term “package” refers to any product or combination of products used to wholly or partially surround a product. A package may take many, various forms. For example, the term “package” may include bags that wholly surround a product (or products) to be packaged; the term “package” may also include films that partially surround a product (or products) to be packaged and, when used in conjunction with another material (such as a tray), wholly surround a product (or products).

As used in the present disclosure, the term “oriented” refers to a monolayer or multilayer film, sheet, or web which has been elongated in a machine direction and/or a transverse direction. Such elongation is accomplished by procedures known to a person of ordinary skill in the art. Non-limiting examples of such procedures include the single bubble blown film extrusion process and the slot case sheet extrusion process with subsequent stretching, for example, by tentering, to provide orientation. Another example of such procedure is the trapped bubble or double bubble process. (See, for example, U.S. Pat. Nos. 3,546,044 and 6,511,688, each of which is incorporated in its entirety in this application by this reference.) In the trapped bubble or double bubble process, an extruded primary tube leaving a tubular extrusion die is cooled, collapsed, and then oriented by reheating, reinflating to form a secondary bubble and re-cooling. Transverse direction orientation may be accomplished by inflation, radially expanding the heated film tube. Machine direction orientation may be accomplished by the use of nip rolls rotating at different speeds, pulling or drawing the film tube in the machine direction. The combination of elongation at elevated temperature followed by cooling causes an alignment of the polymer chains to a more parallel configuration, thereby improving the mechanical properties of the film, sheet, web, package or otherwise.

As used in the present disclosure, the term “directly adjacent” identifies two layers of a film that share an interface, i.e., two layers of the film that contact each other such that a surface forms a common boundary between the two layers.

As used in the present disclosure, the term “haze” refers to the scattering of light as it passes through a material. It refers to the specific light-transmitting and wide-angle-light scattering properties of planar sections of a material. Haze may be determined in accordance with ASTM D-1003-07 (“Standard Test Method for Haze and Luminous Transmittance of Transparent Plastics”). Haze values are reported in percent. A material having a high haze value is generally a material that is more cloudy and less transparent. A material having a low haze value is generally a material that is less cloudy and more transparent. For example, OPET includes a low haze value of approximately 4%.

As used in the present disclosure, the term “gloss” refers to the shiny appearance of a material. It is a measure of the light reflected by the surface of a material and is measured at a specific angle of reflection (20, 45, 60, 75, or 85 degrees) against a specific backing. Gloss may be determined in accordance with ASTM D-2457-08 (“Standard Test Method for Specular Gloss of Plastic Films and Solid Plastics”). Gloss values are reported in Gloss Units. A high gloss value generally indicates a material that is shinier than a material having a lower gloss value.

As used in the present disclosure, the term “glass transition temperature” or “Tg” refers to the temperature below which the physical properties of plastics change in a manner similar to those of a glassy or crystalline state, and above which they behave like rubbery materials. In other words, the glass transition temperature of polymer is the temperature below which molecules have little relative mobility. The glass transition temperature is an important property when considering polymers for a particular end-use. For many practical applications, such as for use as packaging films, the use temperature of the constituent polymers is generally required to be below the glass transition temperature, so that the material at use is in rigid solid state. In other words, the glass transition temperature is a maximum temperature at which polymer material will have one or more useful properties. These properties include impact resistance, stiffness, strength, and shape retention. The glass transition temperature of a polymer therefore may be an indicator of its useful upper temperature limit. The glass transition temperature may be measured using a differential scanning calorimetry method and expressed in degree Celsius (° C.).

As used in the present disclosure, the term “polymeric adhesive layer”, “adhesive layer”, or “tie layer”, refers to a layer or material placed in or on one or more layers to promote the adhesion of that layer to another surface. Preferably, adhesive layers are positioned between two layers of a multilayer film to maintain the two layers in position relative to each other and prevent undesirable delamination. Unless otherwise indicated, an adhesive layer can have any suitable composition that provides a desired level of adhesion with the one or more surfaces in contact with the adhesive layer material. Optionally, an adhesive layer placed between a first layer and a second layer in a multilayer film may include components of both the first layer and the second layer to promote simultaneous adhesion of the adhesive layer to both the first layer and the second layer to opposite sides of the adhesive layer.

As used in the present disclosure, the term “copolymer” refers to a polymer product obtained by the polymerization reaction or copolymerization of at least two monomer species. The term “copolymer” is also inclusive of the polymerization reaction of three, four, or more monomer species having reaction products referred to terpolymers, quaterpolymers, etc.

As used in the present disclosure, the term “polyolefin” refers to polyethylene homopolymers, polyethylene copolymers, polypropylene homopolymers, or polypropylene copolymers.

As used in the present disclosure, the term “polyethylene” refers to polymers that include an ethylene linkage. Polyethylene may be a homopolymer, copolymer or interpolymer. Polyethylene copolymers or interpolymers may include other types of polymers (i.e., non-polyethylene polymers). Polyethylene may have functional groups incorporated by grafting or other means. Polyethylene include, but are not limited to, low-density polyethylene (LDPE), linear low density polyethylene (LLDPE), medium-density polyethylene (MDPE), linear medium-density polyethylene (LMDPE), ultra-low density polyethylene (ULDPE), metallocene low density polyethylene (MLDPE), high-density polyethylene (HDPE), cyclic-olefin copolymers (COC), ethylene vinyl acetate copolymers (EVA), ethylene acrylic acid copolymers (EAA), ethylene methacrylic acid copolymers (EMAA), neutralized ethylene copolymers such as ionomer, and maleic anhydride grafted polyethylene (MAHgPE).

As used in the present disclosure, the term “polyamide” or “PA” or “nylon” refers to a homopolymer or copolymer having an amide linkage between monomer units and formed by any method known in the art. The amide linkage may be represented by the general formula: [C(O)—R—C(O)—NH—R′—NH] n where R and R′ are the same or different alkyl (or aryl) group. Nylon polymers may be high-temperature, low-temperature, or amorphous, as described in, for example, International Publication Number WO 2006/063283. Examples of nylon polymers include, but are not limited to, nylon 6 (polycaprolactam), nylon 11 (polyundecanolactam), nylon 12 (polyauryllactam), nylon 4,2 (polytetramethylene ethylenediamide), nylon 4,6 (polytetramethylene adipamide), nylon 6,6 (polyhexamethylene adipamide), nylon 6,9 (polyhexamethylene azelamide), nylon 6,10 (polyhexamethylene sebacamide), nylon 6,12 (polyhexamethylene dodecanediamide), nylon 7,7 (polyheptamethylene pimelamide), nylon 8,8 (polyoctamethylene suberamide), nylon 9,9 (polynonamethylene azelamide), nylon 10,9 (polydecamethylene azelamide), and nylon 12,12 (polydodecamethylene dodecanediamide). Examples of nylon copolymers include, but are not limited to, nylon 6,6/6 copolymer (polyhexamethylene adipamide/caprolactam copolymer), nylon 6,6/9 copolymer (polyhexamethylene adipamide/azelamide copolymer), nylon 6/6,6 copolymer (polycaprolactam/hexamethylene adipamide copolymer), nylon 6,2/6,2 copolymer (polyhexamethylene ethylenediamide/hexamethylene ethylenediamide copolymer), and nylon 6,6/6,9/6 copolymer (polyhexamethylene adipamide/hexamethylene azelamide/caprolactam copolymer). Examples of aromatic nylon polymers (also sometimes referred to as “amorphous polyamide” or “amorphous nylon”) include, but are not limited to, nylon 4,1, nylon 6,1, nylon 6,6/61 copolymer, nylon 6,6/6T copolymer, nylon MXD6 (poly-m-xylylene adipamide), poly-p-xylylene adipamide, nylon 61/6T copolymer, nylon 6T/61 copolymer, nylon MXDI, nylon 67MXDT/1 copolymer, nylon 6T (polyhexamethylene terephthalamide), nylon 12T (polydodecamethylene terephthalamide), nylon 66T, and nylon 6-3-T (poly(trimethyl hexamethylene terephthalamide).

As used in the present disclosure, the term “cyclic olefin copolymer” refers to copolymers having at least one norbornene structural moiety within the repeating backbone of the polymer. Suitable COCs for use in the present disclosure may have a heat deflection temperature under load (0.45 MPa) of about 75° C., 130° C., 150° C., or 170° C. Exemplary of commercially available cyclic olefin copolymers include, but are not limited to, the TOPAS® family of resins which is supplied by Daicel Corporation and Polyplastics Co., Inc. (Farmington Hills, MI, USA).

As used in the present disclosure, the term “coextruded” or “coextrusion” refer to the process of extruding two or more polymer materials through a single die with two or more orifices arranged so that the extrudates merge and weld together into a laminar structure before chilling, i.e., quenching. The films according to the present disclosure may be fabricated by any coextrusion method known to a person of ordinary skill in the art which may include, but is not limited to, blown film coextrusion, slot cast coextrusion, and extrusion coating.

As used in the present disclosure, the term “thermoplastic” refers to a material that softens when exposed to heat and which substantially returns to a non-softened condition when cooled to room temperature. In some embodiments of the present disclosure, the first web or the second web, and preferably, at least the second web-of the packaging web comprises a thermoplastic material. Alternatively, both the first and second webs of the packaging web include a thermoplastic material.

As used in the present disclosure, the term “recyclate” or “recycled” refers to a polymer-based material being used to form an extruded layer of a film, the polymer-based material having been previously formed into a product (e.g., film) by an extrusion process. The recyclate may be subjected to other processing steps, such as pelletization, between the extrusion that formed the initial product and the extrusion step that now uses the recyclate. The recyclate may be blended with other non-recycled polymer materials.

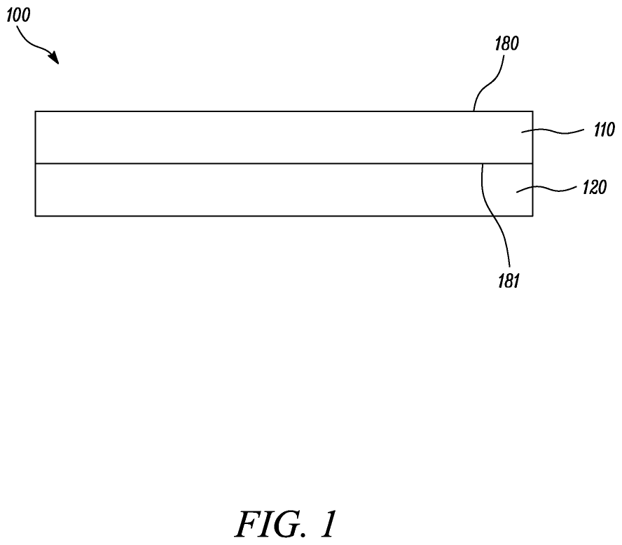

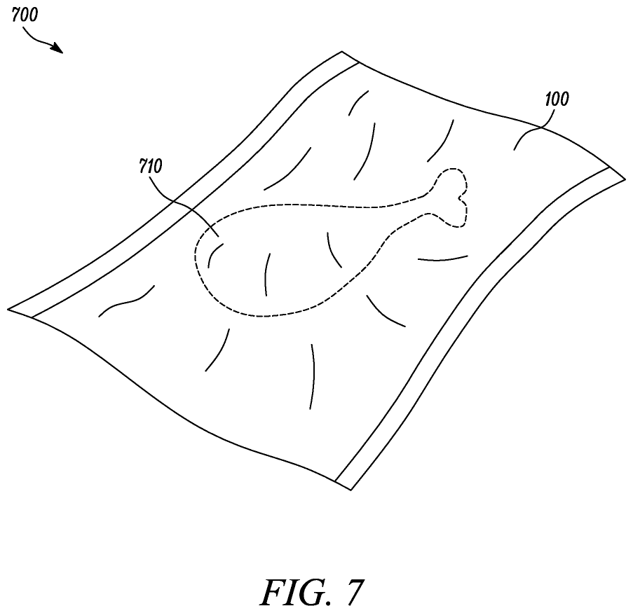

FIG. 1 shows a cross-sectional view of a packaging film 100, in accordance with an embodiment of the present disclosure. Packaging film 100 includes a first layer 110 having a first surface 180 and an opposing second surface 181. First and second surfaces 180, 181 may include respective major surfaces of first layer 110. In some embodiments, first layer 110 may be an outer layer of packaging film 100. In other words, first surface 180 may include a major surface of packaging film 100. In some embodiments, first surface 180 of first layer 110 may be exposed to an external environment, when packaging film 100 is used in a package 700 (shown in FIG. 7).

First layer 110 includes a first layer cyclic olefin copolymer (COC) in an amount from 5% to 30% by weight of first layer 110 and a first layer polyolefin in an amount from 70% to 95% by weight of first layer 110. In other words, first layer 110 includes the first layer cyclic olefin copolymer in an amount from 5% to 30% by weight of first layer 110, and first layer 110 includes the first layer polyolefin in a substantially remaining amount by weight of first layer 110.

In some embodiments, the first layer COC may include norbornene or polynorbornene in an amount greater than or equal to 50%, greater than or equal to 60%, greater than or equal to 70%, or greater than or equal to 80%.

Further, the first layer COC includes a glass transition temperature (Tg) of greater than or equal to 78 degree Celsius (° C.). In some embodiments, the first layer COC includes a Tg of greater than or equal to 80° C., greater than or equal to 90° C., greater than or equal to 100° C., greater than or equal to 120° C., greater than or equal to 130° C., greater than or equal to 140° C., greater than or equal to 150° C., greater than or equal to 160° C., or greater than or equal to 170° C. For example, the COCs having such Tg values may include materials that are recommended for blown film applications, cast film applications, and injection molding applications. It has surprisingly been found that non-blown film grades of COC can deliver the matte effect and thermal resistance to packaging film 100.

The first layer COC in the amount from 5% to 30% by weight of first layer 110 and having the glass transition temperature (Tg) of greater than or equal to 78° C. may further improve a thermal resistance of packaging film 100. In some embodiments, the thermal resistance of packaging film 100 may be equal to or greater than 145° C. In other words, packaging film 100 may be thermally resistant to a temperature of at least about 145° C. In some embodiments, the thermal resistance of packaging film 100 may be equal to or greater than 160° C., equal to or greater than 170° C., equal to or greater than 180° C., equal to or greater than 190° C., or equal to or greater than 200° C.

In some embodiments, the first layer polyolefin includes ultra-low-density polyethylene (ULDPE), low density polyethylene (LDPE), linear low-density polyethylene (LLDPE), medium density polyethylene (MDPE), linear medium density polyethylene (LMDPE), metallocene low density polyethylene (MLDPE), high density polyethylene (HDPE), ethylene vinyl acetate copolymer (EVA), or combinations thereof.

In some embodiments, first layer 110 may include an amorphous phase of the first layer COC dispersed in a matrix of the first layer polyolefin having a semi-crystalline phase.

Packaging film 100 further includes a second layer 120 disposed adjacent to second surface 181 of first layer 110. In other words, packaging film 100 includes second layer 120 disposed adjacent to first layer 110 opposite first surface 180. In some embodiments, second layer 120 may be another outer layer of packaging film 100. In other words, second layer 120 may include another major surface of packaging film 100. In some embodiments, second layer 120 may be exposed to a product (e.g., a product 710 shown in FIG. 7), when packaging film 100 is used in package 700 (shown in FIG. 7).

In some embodiments, second layer 120 includes polyolefin polymers. In some embodiments, second layer 120 includes ultra-low-density polyethylene (ULDPE), low density polyethylene (LDPE), linear low-density polyethylene (LLDPE), medium density polyethylene (MDPE), linear medium density polyethylene (LMDPE), metallocene low density polyethylene (MLDPE), high density polyethylene (HDPE), ethylene vinyl acetate copolymer (EVA), or combinations thereof.

In some embodiments, second layer 120 of packaging film 100 may include a monolayer or may include two or more layers (not shown). Further, each of the two or more layers may have uniform thickness or different thicknesses such that, together, the two or more layers have a total thickness equal to thickness of second layer 120.

First and second layers 110, 120 are coextruded to each other. In some embodiments, second layer 120 may provide support to first layer 110.

In addition, first layer 110, including the first layer polyolefin in the amount from 70% to 95% by weight of first layer 110, may reduce an amount of non-polyolefin-based polymers in packaging film 100 and may provide a better quality of recyclate. Further, second layer 120 including the polyolefin polymers may further reduce an amount of non-polyolefin-based polymers in packaging film 100 and may further improve the quality of recyclate. In some cases, packaging film 100 may be fully recyclable.

Packaging film 100 includes a gloss measurement of less than or equal to 50% when measured according to ASTM D-2457-08 from the first surface 180. In some embodiments, a gloss measurement, when measured according to ASTM D-2457-08, is measured at 60 degrees. In some embodiments, packaging film 100 includes a gloss measurement of less than or equal to 40%, less than or equal to 30%, or less than or equal to 20% when measured according to ASTM D-2457-08. Therefore, packaging film 100 may have a low gloss. In other words, packaging film 100 may have a matte finish that may provide visual appeal to the consumers.

Further, packaging film 100 may not require additional manufacturing steps, such as application of matte coatings. Further, such matte coatings may not be recyclable. Since packaging film 100 may not include such matte coatings, packaging film 100 may have improved recyclability.

In some embodiments, packaging film 100 may include a haze measurement equal to or less than about 80% when measured according to ASTM D-1003-07. Thus, packaging film 100 may have a low gloss or a matte finish, as well as a desirable optical clarity.

In some embodiments, packaging film 100 is oriented. In some embodiments, packaging film 100 may be oriented along a machine direction. In some other embodiments, packaging film 100 may be oriented along a transverse direction. The machine direction may be a general direction along which packaging film 100 travels during a stretching process, such as a machine-direction orientation process. The transverse direction may be an axis within a plane of packaging film 100 and may be orthogonal to the machine direction. In some embodiments, packaging film 100 may be oriented biaxially. In some embodiments, packaging film 100 is a coextruded blown film. In some other embodiments, packaging film 100 is a coextruded cast film.

Packaging film 100 may exhibit improved mechanical properties and stiffness. Specifically, packaging film 100 may have an improved machinability that may allow for packaging film 100 to be downgauged. In other words, packaging film 100 may have a lower thickness than the conventional packaging films for similar applications.

In some embodiments, first layer 110 may be of any desired thickness. In some embodiments, first layer 110 may be between about 5% and about 20% by weight of packaging film 100. Packing films that include first layers that include more than about 20% by weight of the packaging film increase the haze of the packaging film to undesirable levels.

In some embodiments, second layer 120 may be of any desired thickness. In some embodiments, second layer 120 may be between about 80% and about 95% by weight of packaging film 100.

In some embodiments, packaging film 100 further includes a sealant film (not shown in FIG. 1) that may include polyolefin polymers. Exemplary polyolefin polymers may include polyethylene (PE), polypropylene (PP), and polyethylene copolymers such as ethylene vinyl acetate (EVA) copolymer. In some other embodiments, the sealant film may be disposed adjacent to second layer 120, opposite first layer 110. In some embodiments, the sealant film includes an exposed surface of packaging film 100. In some embodiments, the sealant film is coextruded to second layer 120. In some other embodiments, the sealant film may be laminated to the second layer 120.

In some embodiments, one or more intermediate layers (not shown) may be disposed between first and second layers 110, 120. In some embodiments, the one or more intermediate layers may include one or more tie layers including adhesive materials, such as polymeric adhesive material, to aid inter layer adhesion. In other words, packaging film 100 may include the tie layer disposed between first and second layers 110, 120 to aid adhesion between first and second layers 110, 120.

In some embodiments, the one or more intermediate layers may be coextruded with first and second layers 110, 120.

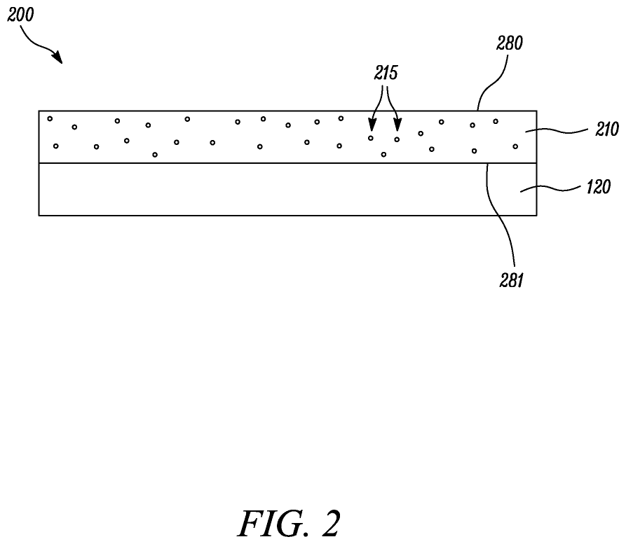

FIG. 2 shows a cross-sectional view of a packaging film 200, in accordance with an embodiment of the present disclosure. Packaging film 200 is substantially similar to packaging film 100 illustrated in FIG. 1. Common components between packaging film 100 and packaging film 200 are depicted by the same reference numerals. However, packaging film 200 further includes an inorganic filler 215.

Packaging film 200 includes a first layer 210 having a first surface 280 and an opposing second surface 281. First and second surfaces 280, 281 may include respective major surfaces of first layer 210. In some embodiments, first layer 210 may be an outer layer of packaging film 200. In other words, first surface 280 may include a major surface of packaging film 200. In some embodiments, first surface 280 of first layer 210 may be exposed to the external environment, when packaging film 200 is used in package 700 (shown in FIG. 7).

First layer 210 may be substantially similar to first layer 110 of packaging film 100 (shown in FIG. 1) with respect to structure and function.

In the illustrated embodiment of FIG. 2, packaging film 200 further includes inorganic filler 215. Specifically, first layer 210 of packaging film 200 includes inorganic filler 215. In some embodiments, inorganic filler 215 may be dispersed in first layer 210. In some embodiments, inorganic filler 215 includes calcium carbonate (CaCO₃), calcium sulfate (CaSO₄), mica, or other silicates, such as aluminum silicate (Al₂SiO₅). In some embodiments, packaging film 200 may include an organic filler in first layer 210. In some embodiments, organic filler may be dispersed in first layer 210. Non-limiting examples of organic filler include plant fibers, microcrystalline cellulose (MCC), nanocrystalline cellulose (NCC)/cellulose nanocrystals (CNCs), cellulose nanofibrils (CNFs), and cellulose whiskers. In some cases, the inorganic filler or the organic filler in the packaging film may further reduce the gloss measurement of the packaging film. In some cases, the inorganic filler or the organic filler may further improve the thermal resistance of the packaging film.

Packaging film 200 includes a gloss measurement of less than or equal to 50% when measured according to ASTM D-2457-08 from first surface 280. In some embodiments, packaging film 200 includes a gloss measurement of less than or equal to 40%, less than or equal to 30%, or less than or equal to 20% when measured according to ASTM D-2457-08. Therefore, packaging film 200 may have a low gloss. In other words, packaging film 200 may have a matte finish that may provide visual appeal to the consumers.

In some embodiments, inorganic filler 215 may further reduce the gloss measurement of packaging film 200, i.e., filler material 215 may further improve the matte finish exhibited by packaging film 200. Additionally, inorganic filler 215 may further improve thermal resistance of packaging film 200. In some embodiments, inorganic filler 215 may be between about 5% and about 30% by weight of first layer 210.

Packaging film 200 includes second layer 120 disposed adjacent to first layer 210 opposite first surface 280, at second surface 281. First and second layers 210, 120 are coextruded to each other. In some embodiments, second layer 120 may provide support to first layer 210.

In addition, first layer 210 may reduce an amount of non-polyolefin-based polymers in packaging film 200 and may provide a better quality of recyclate. Further, second layer 120 may further reduce an amount of non-polyolefin-based polymers in packaging film 200 and may further improve the quality of recyclate.

In some embodiments, packaging film 200 may include a haze measurement equal to or less than about 80% when measured according to ASTM D-1003-07. Thus, packaging film 200 may have a low gloss or a matte finish, as well as a desirable optical clarity.

In some embodiments, packaging film 200 is oriented. In some embodiments, packaging film 200 may be oriented along the machine direction. In some other embodiments, packaging film 100 may be oriented along the transverse direction. In some embodiments, packaging film 200 may be oriented biaxially. In some embodiments, packaging film 200 is a coextruded blown film. In some other embodiments, packaging film 200 is a coextruded cast film.

Packaging film 200 may exhibit improved stiffness. Specifically, packaging film 200 may have an improved machinability that may allow for packaging film 200 to be downgauged. In other words, packaging film 200 may have a lower thickness than the conventional packaging films for similar applications.

In some embodiments, one or more intermediate layers (not shown) may be disposed between first and second layers 210, 120. In some embodiments, the one or more intermediate layers may include one or more tie layers including adhesive materials, such as polymeric adhesive material, to aid inter layer adhesion. In other words, packaging film 200 may include the tie layer disposed between first and second layers 210, 120 to aid adhesion between first and second layers 210, 120.

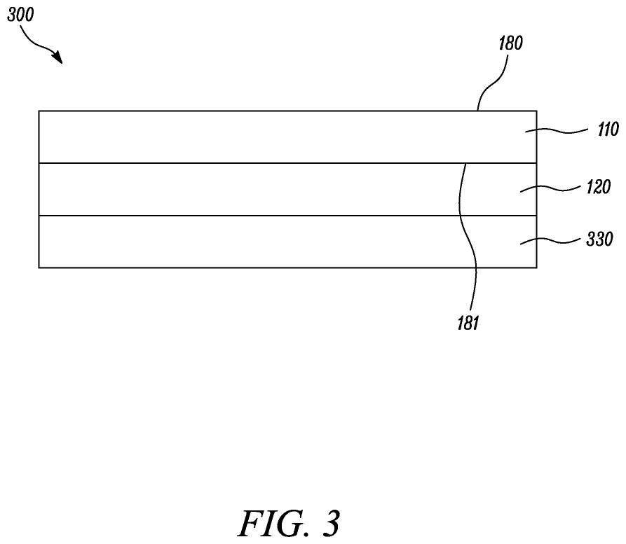

FIG. 3 shows a cross-sectional view of packaging film 300, in accordance with an embodiment of the present disclosure. Packaging film 300 is substantially similar to packaging film 100 illustrated in FIG. 1. Common components between packaging film 100 and packaging film 300 are depicted by the same reference numerals. However, packaging film 300 further includes a third layer 330.

In some embodiments, third layer 330 is disposed adjacent to second layer opposite first layer 110. In some embodiments, third layer 330 may be another outer layer of packaging film 300. In other words, third layer 330 may include another major surface of packaging film 300. In some embodiments, third layer 330 may be exposed to a product (e.g., product 710 shown in FIG. 7), when packaging film 300 is used in package 700 (shown in FIG. 7).

In some embodiments, third layer 330 may be substantially similar to first layer 110. Third layer 330 includes a COC in an amount from 5% to 30% by weight of third layer 330. In some embodiments, third layer 330 further incudes a polyolefin in an amount from 70% to 95% by weight of third layer 330. In other words, third layer 330 includes the COC in an amount from 5% to 30% by weight of third layer 330, and third layer 330 includes the polyolefin in a substantially remaining amount by weight of third layer 330. In embodiments that include third layer 330 including COC in an amount from 5% to 30% by weight of third layer 330, and first layer 110 including COC in an amount from 5% to 30% by weight of first layer 110, the total amount of the COC present in packaging film 300 may be from 10% to 40%, by weight of first layer 110 and third layer 330 combined, and the total amount of polyolefin present in first layer 110 and third layer 330 may be from 60% to 90% by weight of first layer 110 and third layer 330 combined. In some embodiments, third layer may not be substantially similar to first layer; that is, third layer may not include COC in an amount from 5% to 30% by weight of the third layer and may include substantially 100% polyolefin.

In some embodiments, the polyolefin of third layer 330 may include ultra-low-density polyethylene (ULDPE), low density polyethylene (LDPE), linear low-density polyethylene (LLDPE), medium density polyethylene (MDPE), linear medium density polyethylene (LMDPE), metallocene low density polyethylene (MLDPE), high density polyethylene (HDPE), ethylene vinyl acetate copolymer (EVA), or combinations thereof.

Further, the COC of third layer 330 includes a glass transition temperature (Tg) of greater than or equal to 78° C. In some embodiments, the COC of third layer 330 includes a Tg of greater than or equal to 80° C., greater than or equal to 90° C., greater than or equal to 100° C., greater than or equal to 120° C., greater than or equal to 130° C., greater than or equal to 140° C., greater than or equal to 150° C., greater than or equal to 160° C., or greater than or equal to 170° C. For example, COCs including such Tg values may include materials that are recommended for blown film applications, cast film applications, and injection molding applications. Further, non-blown film grades of COC may deliver the matte effect and thermal resistance to packaging film 300.

In some embodiments, an amorphous phase of the COC of third layer 330 may be dispersed in a matrix of the polyolefin having a semi-crystalline phase.

In some embodiments, third layer 330 may reduce tendency of packaging film 300 to curl at the elevated temperatures. Thus, inclusion of third layer 330 may provide a symmetric, non-curling packaging film 300.

In some embodiments, first, second and third layers 110, 120, 330 are coextruded to each other. In some embodiments, packaging film 300 is oriented. In some embodiments, packaging film 300 may be oriented along the machine direction. In some other embodiments, packaging film 300 may be oriented along the transverse direction. In some embodiments, packaging film 300 may be oriented biaxially. In some embodiments, packaging film 300 may be a coextruded blown film. In some other embodiments, packaging film 300 may be a coextruded cast film.

In some embodiments, third layer 330 may be of any desired thickness. In some embodiments, third layer 330 may be between about 5% and about 20% by weight of packaging film 300.

In some embodiments, one or more intermediate layers (not shown) may be disposed between first and third layers 110, 330. In some embodiments, the one or more intermediate layers may include one or more tie layers including adhesive materials, such as polymeric adhesive material, to aid inter layer adhesion.

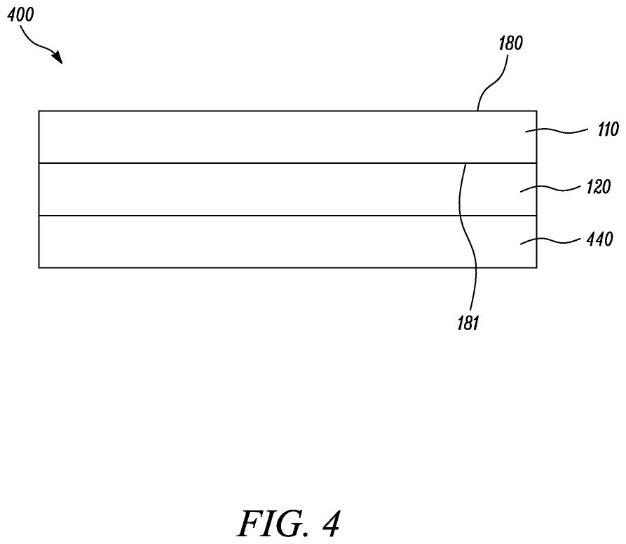

FIG. 4 shows a cross-sectional view of packaging film 400, in accordance with an embodiment of the present disclosure. Packaging film 400 is substantially similar to packaging film 100 illustrated in FIG. 1. Common components between packaging film 100 and packaging film 400 are depicted by the same reference numerals. However, packaging film 400 further includes a barrier layer 440.

In the illustrated embodiment of FIG. 4, barrier layer 440 is disposed adjacent to second layer 120, opposite first layer 110. In such embodiments, barrier layer 440 may be another outer layer of packaging film 400. In other words, barrier layer 440 may include another major surface of packaging film 400. In some embodiments, barrier layer 440 may be exposed to a product (e.g., product 710 shown in FIG. 7), when packaging film 400 is used in package 700 (shown in FIG. 7). In some other embodiments, barrier layer 440 may be disposed on second surface 181. In other words, barrier layer 440 may be disposed between first layer 110 and second layer 120.

Barrier layer 440 may include any material that has an oxygen transmission rate and/or a moisture vapor transmission rate that is lower than other components of packaging film 400. In some embodiments, barrier layer 440 may include an oxygen barrier material. In some embodiments, barrier layer 440 may include a moisture vapor barrier material. In some embodiments, barrier layer 440 may include ethylene-vinyl alcohol (EVOH) and/or HDPE.

In some embodiments, first and second layers 110, 120, and barrier layer 440 are coextruded to each other. In some embodiments, barrier layer 440 is laminated to second layer 120 of packaging film 400.

In some embodiments, packaging film 400 is oriented. In some embodiments, packaging film 400 may be oriented along the machine direction. In some other embodiments, packaging film 400 may be oriented along the transverse direction. In some embodiments, packaging film 400 may be oriented biaxially. In some embodiments, packaging film 400 may be a coextruded blown film. In some other embodiments, packaging film 400 may be a coextruded cast film.

In some embodiments, one or more intermediate layers (not shown) may be disposed between first layer 110 and barrier layer 440. In some embodiments, the one or more intermediate layers may be coextruded with first and second layers 110, 120, and the barrier layer 440.

In some embodiments, packaging film 400 may further include third layer 330 (shown in FIG. 3). In some embodiments, third layer 330 may be disposed adjacent to second layer 120, opposite first layer 110. In such embodiments, barrier layer 440 may be disposed adjacent to third layer 330, opposite second layer 120. In some other embodiments, barrier layer 440 may be disposed adjacent to second layer 120, opposite first layer 110. In such embodiments, third layer 330 may be disposed adjacent to barrier layer 440, opposite second layer 120, i.e., barrier layer 440 is disposed between second layer 120 and third layer 330. In some embodiments, first, second and third layers 110, 120, 330, and barrier layer 440 are coextruded to each other.

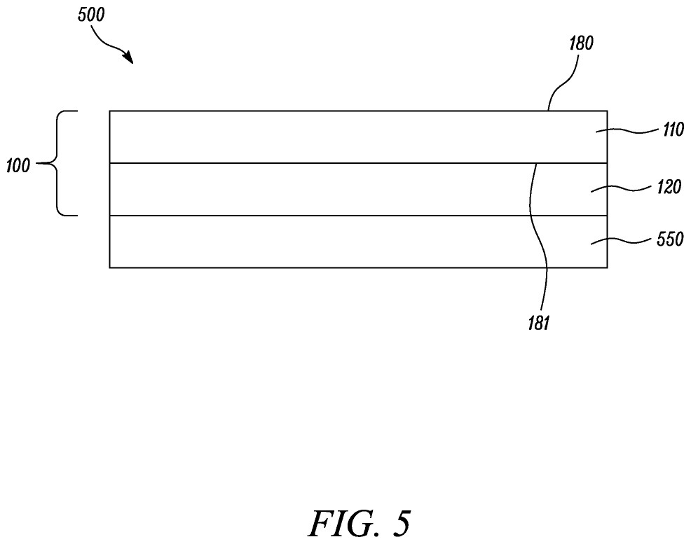

FIG. 5 shows a cross-sectional view of a laminated packaging film 500, in accordance with an embodiment of the present disclosure. Laminated packaging film 500 includes packaging film 100 and a sealant film 550. However, in some embodiments, laminated packaging film 500 may include packaging film 200, packaging film 300, or packaging film 400, illustrated in FIGS. 2-4, respectively.

In some embodiments, first layer 110 may be an outer layer of laminated packaging film 500. In other words, first surface 180 may include a major surface of laminated packaging film 500. In some embodiments, first surface 180 of first layer 110 may be exposed to the external environment, when packaging film 100 is used in a package 700 (shown in FIG. 7). In the illustrated embodiment of FIG. 5, sealant film 550 is disposed adjacent to second layer 120, opposite first layer 110. In some embodiments, additional layers may be in between the second layer 120 and sealant film 550. Sealant film 550 may be another outer layer of laminated packaging film 500. In other words, sealant film 550 includes an exposed surface of laminated packaging film 500. In some embodiments, sealant film 550 may be exposed to a product (e.g., product 710 in FIG. 7), when laminated packaging film 500 is used in package 700 (shown in FIG. 7).

In some embodiments, sealant film 550 is laminated to packaging film 100. In some embodiments, packaging film 100 and sealant film 550 are laminated by heat, extrusion or adhesive. In some embodiments, sealant film 550 includes polyolefin polymers. Exemplary polyolefin polymers may include polyethylene (PE), polypropylene (PP), and polyethylene copolymers such as ethylene vinyl acetate (EVA) copolymer.

In some embodiments, laminated packaging film 500 is oriented. In some embodiments, laminated packaging film 500 may be oriented along the machine direction. In some other embodiments, laminated packaging film 500 may be oriented along the transverse direction. In some embodiments, laminated packaging film 500 may be oriented biaxially.

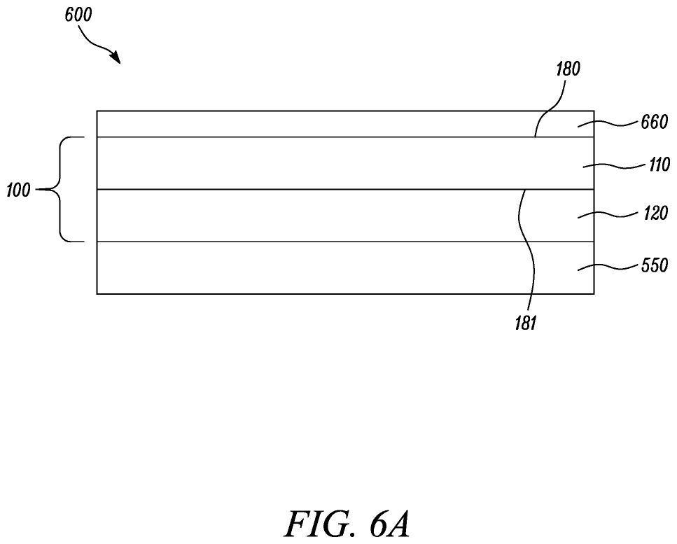

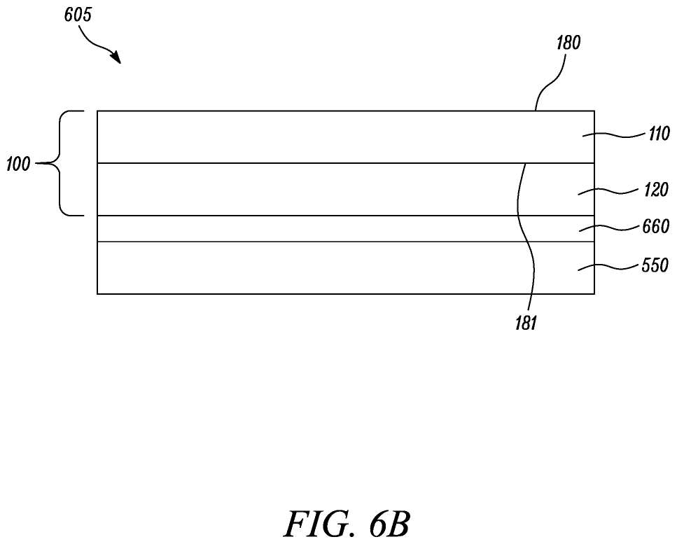

FIG. 6A shows a cross-sectional view of a laminated packaging film 600, in accordance with an embodiment of the present disclosure. Laminated packaging film 600 is substantially similar to laminated packaging film 500 illustrated in FIG. 5. Common components between laminated packaging film 600 and laminated packaging film 500 are depicted by the same reference numerals. However, laminated packaging film 600 further includes printed indicia.

Laminated packaging film 600 further includes printed indicia. Printed indicia may be included in an ink layer 660. In the illustrated embodiment of FIG. 6A, ink layer 660 is disposed on first surface 180 of first layer 110.

In some embodiments, laminated packaging film 600 is oriented. In some embodiments, laminated packaging film 600 may be oriented along the machine direction. In some other embodiments, laminated packaging film 600 may be oriented along the transverse direction. In some embodiments, laminated packaging film 600 may be oriented biaxially.

FIG. 6B shows a cross-sectional view of a laminated packaging film 605, in accordance with an embodiment of the present disclosure. Laminated packaging film 605 is substantially similar to laminated packaging film 600 illustrated in FIG. 6A. However, ink layer 660 is disposed adjacent to second layer 120, opposite second surface 181. Ink layer 660 may be disposed prior to lamination of packaging film 100 with sealant film 550, such that, after lamination of packaging film 100 with sealant layer 550, ink layer 660 is positioned between second layer 120 and sealant layer 550.

In some embodiments, laminated packaging film 605 is oriented. In some embodiments, laminated packaging film 605 may be oriented along the machine direction. In some other embodiments, laminated packaging film 605 may be oriented along the transverse direction. In some embodiments, laminated packaging film 605 may be oriented biaxially.

FIG. 7 shows a perspective view of package 700 including packaging film 100, for a product 710 disposed therein, in accordance with an embodiment of the present disclosure. However, in some embodiments, package 700 may include packaging film 200, packaging film 300, packaging film 400, laminated packaging film 500, or laminated packaging film 600 illustrated in FIGS. 2-6, respectively.

As shown in FIG. 7, packaging film 100 is sealed to itself or any other packaging component to form package 700 for enclosing product 710. In some cases, package 700 may be hermetically sealed around product 710 for protection.

In the illustrated embodiment of FIG. 7, product 710 in package 700 may include a solid, a liquid and/or a semi-solid product. In some other embodiments, product 710 may be, food or non-food items. Non-limiting examples include a personal care product, a pet food, a medical product, a pharmaceutical product, a first aid product, a nutritional aid product, or a beverage. Package 700 may take any number of forms including pouches, bags, trays/lids, clamshells, boxes, sachets, flow wrap, or bottles. In some embodiments, package 700 may be in a form of cup/lid. The lid of the cup/lid package may include packaging film 100. Package 700 may include a single serving or may have multiple servings. Package 700 may include additional features such as a zipper for reclose. In some embodiments, packaging film 100 is required to be heat sealable. Heat sealing requires portions of packaging film 100 to be heat resistant and portions of packaging film 100 to be capable of forming a strong seal with another packaging component.

Packaging film 100 may have thermal resistance equal to or greater than 145° C. Accordingly, package 700 including packaging film 100 may also have an improved thermal resistance. Further, packaging film 100 includes the gloss measurement of less than or equal to 50% when measured according to ASTM D-2457-08. Therefore, package 700 including packaging film 100 may also have a low gloss. In other words, package 700 may have a matte finish. Moreover, package 700 may not contaminate a recycling stream such that package 700 may be recyclable.

### EXAMPLES AND DATA

The following examples are offered for illustrative purposes only and are not intended to limit the scope of the claims in any way. Indeed, various modifications of the disclosure in addition to those shown and described herein will become apparent to those skilled in the art from the foregoing description and the following examples and fall within the scope of the appended claims.

Different sample packaging films were produced. Specifically, sample films A-G were produced.

Table 1 below provides different compositions of the sample films. Amount of each material is depicted as a weight percentage of corresponding layer in which the material is present. The materials used included high density polyethylene (HDPE), cyclic olefin copolymer (COC), polyamide (PA), metallocene low density polyethylene (MLDPE), calcium carbonate (CaCO₃), and oriented polyethylene terephthalate (OPET). Specifically, for sample films C and E, COC used was COC-5013, available from TOPAS® family of resins, Daicel Corporation and Polyplastics Co., Inc. (Farmington Hills, MI, USA).

TABLE 1
Compositions of Sample Films

| Sample | First Layer | Second Layer | Third Layer |
|---|---|---|---|
| Sample film A | 100% HDPE | 100% MLDPE | 100% HDPE |
| Sample film B | 63% HDPE + 37% | 100% MLDPE | 100% HDPE |
| | CaCO3 (1 μm) | | |
| Sample film C | 80% HDPE + 20% | 100% MLDPE | 80% HDPE + |
| | COC (MDO) | | 20% COC |
| Sample film D | 100% PA (MDO) | 100% MLDPE | 100% PA |
| Sample film E | 80% HDPE + 20% | 100% MLDPE | 80% HDPE + |
| | COC (Blown) | | 20% COC |
| Sample film F | 52% HDPE + 20% | 100% MLDPE | 80% HDPE + |
| | COC + 28% CaCO3 | | 20% COC |
| | (1 μm) (Blown) | | |

| | |
|---|---|
| Sample film G | OPET based |

Sample films C and E had a construction similar to that of packaging film 300 illustrated in FIG. 3. Sample film F had a construction similar to that of packaging film 200 illustrated in FIG. 2.

Sample film C was oriented in machine direction. Sample film C was produced by coextruding a three-layered structure having a thickness of about 127 microns (5 mils) (e.g., first, second and third layers 110, 120, 330 shown in FIG. 3). Sample film C was stretched up to about 5 times to obtain a thickness of about 25.4 microns (1 mil). Sample film E was a coextruded blown film. Sample film F was a coextruded blown film. Sample films A, B, D, and G were conventional packaging films.

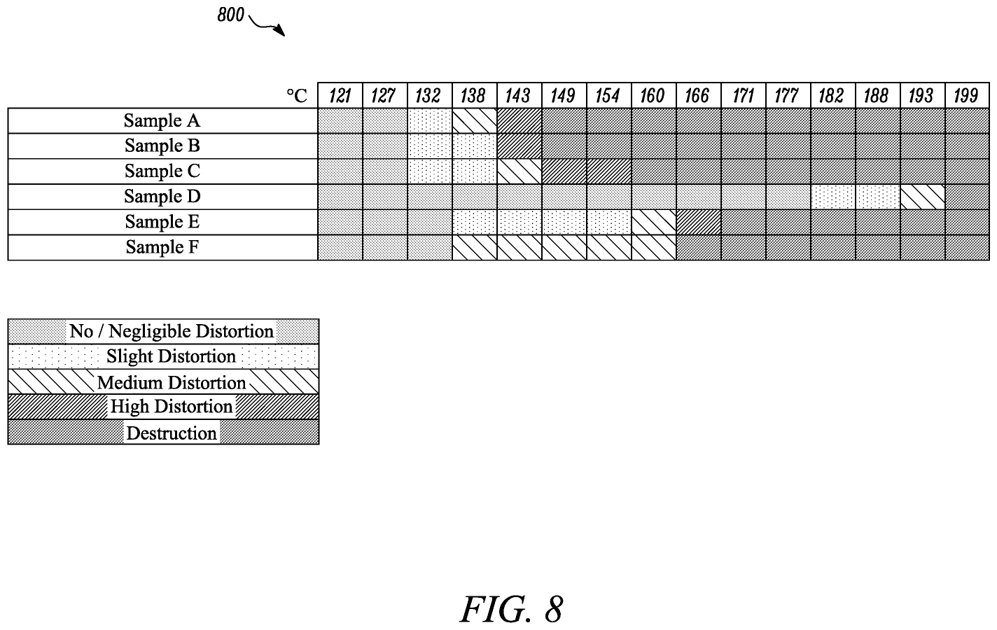

FIG. 8 shows a plot 800 depicting thermal resistance of sample films A-F according to Table 1. Plot 800 depicts five stages of different sample films A-F undergoing thermal resistance measurement. The five stages were visually observed at various temperatures during thermal resistance measurement. The five stages were,
i. No/negligible distortion
ii. Slight distortion
iii. Medium distortion
iv. High distortion
V. Destruction

Thermal resistance was measured by sealing first layer of each of sample films A-F to itself by placing first layer against a heated metal seal jaw (without non-stick coating e.g., TEFLON coating). An initial seal test temperature was about 121° C. at a pressure of about 0.276 MPa and dwell time of 1 second. The temperature was increased in increments of about 6° C., while keeping the pressure and the dwell time constant. Packaging film 800 was visually inspected after each increment in temperature.

As shown in plot 800, sample film A showed no/negligible distortion up to about 132° C., a slight distortion from about 132° C. to about 138° C., a medium distortion from about 138° C. to about 143° C., a high distortion from about 143° C. to about 149° C. and destruction after about 149° C. Sample film B showed no/negligible distortion up to about 132° C., a slight distortion from about 132° C. to about 143° C., a high distortion from about 143° C. to about 149° C., and destruction after about 149° C.

As shown in plot 800, sample film D showed no/negligible distortion up to about 182° C., a slight distortion from about 182° C. to about 193° C., a medium distortion from about 193° C. to about 199° C., and destruction after about 199° C.

As shown in plot 800, sample film C showed no/negligible distortion up to about 132° C., a slight distortion from about 132° C. to about 143° C., a medium distortion from about 143° C. to about 149° C., a high distortion from about 149° C. to about 160° C., and destruction after about 160° C. Sample film E showed no/negligible distortion up to about 138° C., a slight distortion from about 138° C. to about 160° C., a medium distortion from about 160° C. to about 166° C., a high distortion from about 166° C. to about 171° C., and destruction after about 171° C.

As shown in plot 800, sample film F showed no/negligible distortion up to about 138° C., a medium distortion from about 138° C. to about 166° C., and destruction after about 166° C.

As is apparent from plot 800, sample films C, E and F including HPDE and COC blends showed improved thermal resistance compared to sample films A and B. Sample film D showed superior thermal resistance. However, sample film D that includes polyamide may contaminate polyolefin recycling streams.

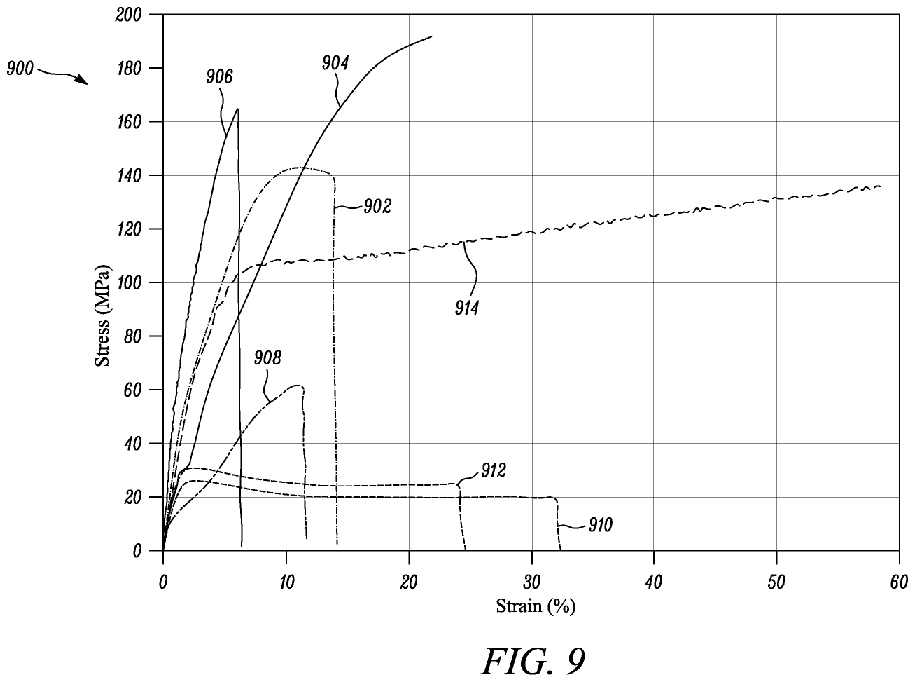

FIG. 9 shows a plot 900 depicting stress versus strain curves of different sample films A-G as measured according to ASTM D882-12 (“Standard Test Method for Tensile Properties of Thin Plastic Sheeting”). Strain is expressed as a strain percentage (%) in abscissa. Stress is expressed in megapascals (MPa) in the left ordinate.

Plot 900 includes a stress versus strain curve 902 for sample film A, stress versus strain curve 904 for sample film B, stress versus strain curve 906 for sample film C, stress versus strain curve 908 for sample film D, stress versus strain curve 910 for sample film E, stress versus strain curve 912 for sample film F, and stress versus strain curve 914 for sample film G. The stress versus strain curves 902, 904, 906, 908, 910, 912, 914 were measured along the machine direction (MD).

From curve 906 of plot 900, it was observed that sample film C exhibited improved stiffness compared to sample films A, B, D, E, F, G. The improved stiffness may translate to better machinability of sample film C that may allow sample film C to be downgauged. In other words, sample film C may have a lower thickness than sample films A, B, D, E, F, G for similar applications.

From plots 800, 900, it was observed that sample film C exhibited a combination of improved thermal resistance and improved stiffness compared to other sample films. Sample films E and F exhibited improved thermal resistance.

Table 2 provides gloss values of different compositions of packaging film 800. Gloss was measured as a percentage, and was measured at an angle of 60 degrees, according to ASTM D-2457-08.

TABLE 2
Gloss Measurements

| Sample | Gloss % at 60 degrees |
|---|---|
| Sample film A | 75-85 |
| Sample film B | 8-15 |
| Sample film C | 30-50 |
| Sample film E | 20-40 |
| Sample film F | 15-20 |
| Sample film G | 105-115 |

From Table 2, it is apparent that sample films C, E and F exhibited a gloss measurement of less than or equal to 50%. Sample film B exhibited a gloss measurement of between 8% and 15%. Sample film A exhibited high gloss measurement of between 75% and 85%. Sample film G exhibited a high gloss measurement of between 105% and 115%.

Each of packaging films 100, 200, 300, 400 includes the gloss measurement of less than or equal to 50% when measured according to ASTM D-2457-08. Therefore, each of packaging films 100, 200, 300, 400 may have low gloss. In other words, each of packaging films 100, 200, 300, 400 may have matte finish. Further, each of packaging films 100, 200, 300, 400 may not require the additional manufacturing steps, such as application of matte coatings, to obtain the matte finish. First layer 110, 210 of packaging films 100, 200, 300, 400 include the glass transition temperature of greater than or equal to 78° C. Thermal resistance of each of packaging films 100, 200, 300, 400 may be equal to or greater than 145° C. Each of packaging films 100, 200, 300, 400 exhibits improved stiffness and improved mechanical properties, specifically along the machine direction. Therefore, packaging films 100, 200, 300, 400 have improved machinability and may be downgauged. Additionally, first layer 110, 210, including the first layer polyolefin in the amount from 60% to 90% by weight of the first layer 110, 210, may reduce an amount of non-polyolefin-based polymers in the corresponding packaging film and may provide a better quality of recyclate. Further, the second layer 120 including the polyolefin polymers may further reduce an amount of non-polyolefin-based polymers in the corresponding packaging film and may further improve the quality of recyclate. In some cases, the packaging film may be fully recyclable.

### EMBODIMENTS

### Packaging Film Embodiments:

A. A packaging film comprising a first layer having a first surface and an opposing second surface, the first layer comprising a first layer cyclic olefin copolymer in an amount from 5% to 30% by weight of the first layer and a first layer polyolefin in an amount from 70% to 95% by weight of the first layer, and a second layer disposed adjacent to the second surface of the first layer; wherein the first layer and the second layer are coextruded to each other, wherein the packaging film comprises a gloss measurement of less than or equal to 50% when measured according to ASTM D-2457-08, and wherein the first layer cyclic olefin copolymer comprises a glass transition temperature (Tg) of greater than or equal to 78 degree Celsius (° C.).
B. The packaging film according to any of Embodiments A or D-N, wherein the packaging film is a coextruded blown film.
C. The packaging film according to any of Embodiments A or D-N, wherein the packaging film is a coextruded cast film.
D. The packaging film according to any of Embodiments A-C or E-N, wherein the packaging film is oriented.
E. The packaging film according to any of Embodiments A-D or F-N, wherein the first layer polyolefin comprises ultra-low-density polyethylene, low density polyethylene, linear low-density polyethylene, medium density polyethylene, linear medium density polyethylene, metallocene low density polyethylene, high density polyethylene, ethylene vinyl acetate copolymer (EVA), or combinations thereof.
F. The packaging film according to any of Embodiments A-E or G-N, wherein the second layer comprises polyolefin polymers.
G. The packaging film according to any of Embodiments A-F or H-N, further comprising a thermal resistance equal to or greater than 145 degree Celsius (° C.).
H. The packaging film according to any of Embodiments A-G or I-N, further comprising an inorganic filler comprising calcium carbonate, calcium sulfate, mica, or other silicates.
I. The packaging film according to any of Embodiments A-H or J-N, further comprising a third layer comprising a cyclic olefin copolymer in an amount from 5% to 30% by weight of the third layer.
J. The packaging film according to any of Embodiments A-I or K-N, further comprising a barrier layer.
K. The packaging film according to any of Embodiments A-J or L-N further comprising printed indicia.
L. The packaging film according to any of Embodiments A-K or M-N, further comprising a sealant film comprising an exposed surface of the packaging film.
M. The packaging film according to Embodiment L, wherein the sealant film is laminated to the packaging film.
N. The packaging film according to any of Embodiments L-M, wherein the packaging film and the sealant film are laminated by heat, extrusion or adhesive.

### Laminated Packaging Film Embodiments:

O. A laminated packaging film comprising a packaging film comprising a first layer having a first surface and an opposing second surface, the first layer comprising a first layer cyclic olefin copolymer in an amount from 5% to 30% by weight of the first layer and a first layer polyolefin in an amount from 70% to 95% by weight of the first layer and a second layer disposed adjacent to the second surface of the first layer, and a sealant film; wherein the first layer and the second layer are coextruded to each other, wherein the sealant film is laminated to the packaging film and comprises an exposed surface of the packaging film, wherein the packaging film comprises a gloss measurement of less than or equal to 50% when measured according to ASTM D-2457-08, and wherein the first layer cyclic olefin copolymer comprises a glass transition temperature (Tg) of greater than or equal to 78 degree Celsius (° C.).
P. The laminated packaging film according to any of Embodiments O or R-Z, wherein the packaging film is a coextruded blown film.
Q. The laminated packaging film according to any of Embodiments O or R-Z, wherein the packaging film is a coextruded cast film.
R. The laminated packaging film according to any of Embodiments O-Q or S-Z, wherein the packaging film is oriented.
S. The laminated packaging film according to any of Embodiments O-R or T-Z, wherein the first layer polyolefin comprises ultra-low-density polyethylene, low density polyethylene, linear low-density polyethylene, medium density polyethylene, linear medium density polyethylene, metallocene low density polyethylene, high density polyethylene, ethylene vinyl acetate copolymer (EVA), or combinations thereof.
T. The laminated packaging film according to any of Embodiments O-S or U-Z, further comprising a thermal resistance equal to or greater than 145 degree Celsius (° C.).
U. The laminated packaging film according to any of Embodiments O-T or V-Z, further comprising an inorganic filler comprising calcium carbonate, calcium sulfate, mica, or other silicates.
V. The laminated packaging film according to any of Embodiments O-U or W-Z, further comprising a third layer comprising a cyclic olefin copolymer in an amount from 5% to 30% by weight of the third layer.
W. The laminated packaging film according to any of Embodiments O-V or X-Z, further comprising a barrier layer.
X. The laminated packaging film according to any Embodiments O-W or Y-Z, wherein the packaging film and the sealant film are laminated by heat, extrusion, or adhesive.
Y. The laminated packaging film according to any Embodiments O-X or Z, further comprising printed indicia.
Z. The laminated packaging film according to any Embodiments O-Y, wherein the second layer comprises polyolefin polymers.

### Packaging Film Embodiments:

AA. A package comprising the packaging film according to any of Embodiments A-N or comprising the laminated packaging film according to Embodiments O-Z.

Each and every document cited in this present application, including any cross referenced, is incorporated in this present application in its entirety by this reference, unless expressly excluded or otherwise limited. The citation of any document is not an admission that it is prior art with respect to any embodiment disclosed in this present application or that it alone, or in any combination with any other reference or references, teaches, suggests, or discloses any such embodiment. Further, to the extent that any meaning or definition of a term in this present application conflicts with any meaning or definition of the same term in a document incorporated by reference, the meaning or definition assigned to that term in this present application governs.

Unless otherwise indicated, all numbers expressing sizes, amounts, ranges, limits, and physical and other properties used in the present application are to be understood as being preceded in all instances ay the term “about”. Accordingly, unless expressly indicated to the contrary, the numerical parameters set forth in the present application are approximations that can vary depending on the desired properties sought to be obtained by a person of ordinary skill in the art without undue experimentation using the teachings disclosed in the present application.

As used in the present application, the singular forms “a”, “an”, and “the” encompass embodiments having plural referents, unless the context clearly dictates otherwise. As used in the present application, the term “or” is generally employed in its sense including “and/or”, “unless” the context clearly dictates otherwise.

Spatially related terms, including but not limited to, “lower”, “upper”, “beneath”, “below”, “above”, “bottom” and “top”, if used in the present application, are used for ease of description to describe spatial relationships of an element(s) to another. Such spatially related terms encompass different orientations of the device in use or operation, in addition to the particular orientations depicted in the figures and described in the present application. For example, if an object depicted in the drawings is turned over or flipped over, elements previously described as below, or beneath other elements would then be above those other elements.

The drawings show some but not all embodiments. The elements depicted in the drawings are illustrative and not necessarily to scale, and the same or similar) reference numbers denote the same (or similar) features throughout the drawings.

The description, examples, embodiments, and drawings disclosed are illustrative only and should not be interpreted as limiting. The present invention includes the description, examples, embodiments, and drawings disclosed; but it is not limited to such description, examples, embodiments, or drawings. As briefly described above, the reader should assume that features of one disclosed embodiment can also be applied to all other disclosed embodiments, unless expressly indicated to the contrary. Modifications and other embodiments will be apparent to a person of ordinary skill in the packaging arts, and all such modifications and other embodiments are intended and deemed to be within the scope of the present invention.

1. A packaging film comprising:
a first layer having a first surface and an opposing second surface, the first layer comprising a first layer cyclic olefin copolymer in an amount from 5% to 30% by weight of the first layer and a first layer polyolefin in an amount from 70% to 95% by weight of the first layer, and
a second layer disposed adjacent to the second surface of the first layer;
wherein the first layer and the second layer are coextruded to each other,
wherein the packaging film comprises a gloss measurement of less than or equal to 50% when measured according to ASTM D-2457-08, and
wherein the first layer cyclic olefin copolymer comprises a glass transition temperature (Tg) of greater than or equal to 78 degree Celsius (° C.).

2. The packaging film of claim 1, wherein the packaging film is a coextruded blown film.

3. The packaging film of claim 1, wherein the packaging film is a coextruded cast film.

4. The packaging film of claim 1, wherein the packaging film is oriented.

5. The packaging film of claim 1, wherein the first layer polyolefin comprises ultra-low-density polyethylene, low density polyethylene, linear low-density polyethylene, medium density polyethylene, linear medium density polyethylene, metallocene low density polyethylene, high density polyethylene, ethylene vinyl acetate copolymer (EVA), or combinations thereof.

6. The packaging film of claim 1, wherein the second layer comprises polyolefin polymers.

7. The packaging film of claim 1, further comprising a thermal resistance equal to or greater than 145 degree Celsius (° C.).

8. The packaging film of claim 1, further comprising an inorganic filler comprising calcium carbonate, calcium sulfate, mica, or other silicates.

9. The packaging film of claim 1, further comprising a third layer comprising a cyclic olefin copolymer in an amount from 5% to 30% by weight of the third layer.

10. The packaging film of claim 1, further comprising a barrier layer.

11. The packaging film of claim 1, further comprising a sealant film comprising an exposed surface of the packaging film.

12. The packaging film of claim 11, wherein the sealant film is laminated to the packaging film.

13. A package comprising the packaging film of claim 1.

14. A laminated packaging film comprising:
a packaging film comprising a first layer having a first surface and an opposing second surface, the first layer comprising a first layer cyclic olefin copolymer in an amount from 5% to 30% by weight of the first layer and a first layer polyolefin in an amount from 70% to 95% by weight of the first layer and a second layer disposed adjacent to the second surface of the first layer, and
a sealant film;
wherein the first layer and the second layer are coextruded to each other,
wherein the sealant film is laminated to the packaging film and comprises an exposed surface of the packaging film,
wherein the packaging film comprises a gloss measurement of less than or equal to 50% when measured according to ASTM D-2457-08, and
wherein the first layer cyclic olefin copolymer comprises a glass transition temperature (Tg) of greater than or equal to 78 degree Celsius (° C.).

15. The laminated packaging film of claim 14, wherein the packaging film is oriented.

16. The laminated packaging film of claim 14, wherein the packaging film and the sealant film are laminated by heat, extrusion, or adhesive.

17. The laminated packaging film of claim 14, further comprising printed indicia.

18. The laminated packaging film of claim 14, wherein the second layer comprises polyolefin polymers.

19. The laminated packaging film of claim 14, wherein the packaging film further comprises a thermal resistance equal to or greater than 145 degree Celsius (° C.).

20. A package comprising the laminated packaging film of claim 14.
